(19) United States
(12) Patent Application Publication
(10) Pub. No.: US 2008/0004749 A1
(43) Pub. Date: Jan. 3, 2008

(54) System and method for generating instructions for a robot

(75) Inventor: Randy W. Hostettler, Phoenix, AZ (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International, Inc.

(21) Appl. No.: 11/479,784

(22) Filed: Jun. 30, 2006

(51) Int. Cl. G06F 19/00

(52) U.S. Cl. 700/245

(57) ABSTRACT

A system and method are provided for generating instructions for at least one robot to execute a mission in an environment. An environment builder is adapted to receive information related to the environment and to form a model of the environment based on the information. A simulator is coupled to the environment builder and its model and adapted to receive inputs from a human operator to virtually execute the mission within the simulation. A blueprint generator is coupled to the simulator and adapted to generate a mission blueprint of the instructions based on the virtual execution of the mission for subsequent execution by one or more robots.

### FIELD OF THE INVENTION

The present invention generally relates to a system and method for generating instructions for a robot.

### BACKGROUND OF THE INVENTION

Autonomous systems are systems having some degree of self-operation. One class of autonomous systems has a robot or a team of robots that reduce or eliminate the human component of labor intensive operations. However, autonomous planning and mission execution for robots can present artificial intelligence challenges, in part, because artificial intelligence is still in a state of relative infancy. Algorithms for executing missions are still relatively limited in capability, can be error-prone, and may be stymied by the general randomness of nature to which humans more easily interpret and adapt. Additionally, resources such as processing, memory, storage and the like that support such autonomous activities can be significant, undesirable, and, in some cases, prohibitive, for example, in space or other-planetary environments. Human-assisted and human-in-the-loop robotics are known techniques to overcome these obstacles by providing human input to the autonomous activities. This reduces the required artificial intelligence and resource requirements, but may present additional problems. For example, a sequence of events that a human can conceptualize in a few seconds or minutes may take a robotic system many hours or days to complete. Maintaining human assistance for this timeframe is costly and inefficient, and particularly tedious. Additionally, when large distances (e.g., for space-based or other-planetary operations) separate the human from the robots, time lags between human direction and robotic action and feedback become problematic.

Accordingly, it is desirable to provide an improved system and method for generating instructions for autonomous tasks.

Desirable features and characteristics of the present invention will become apparent from the subsequent detailed description of the invention and the appended claims, taken in conjunction with the accompanying drawings and this background of the invention.

### BRIEF SUMMARY OF THE INVENTION

In one exemplary embodiment, a system is provided for generating instructions for at least one robot to execute a mission in an environment. An environment builder is adapted to receive information related to the environment and form a simulation of the environment based on the information. A simulator is coupled to the environment builder and adapted to receive inputs from a human operator to virtually execute the mission. A blueprint generator is coupled to the simulator and adapted to generate a mission blueprint of the instructions based on the virtual execution of the mission.

In another exemplary embodiment, a method is provided for generating instructions for at least one robot to execute a mission in an environment. The method includes receiving information related to the environment; forming a simulation of the environment based on the information; receiving inputs from a human operator to virtually execute the mission; and generating a mission blueprint of the instructions based on the virtual execution of the mission.

In another exemplary embodiment, a system is provided for autonomous execution of a mission in an environment. The system includes an environment builder adapted to receive information related to the environment and to form a model of the environment based on the information; a simulator coupled to receive the model from the environment builder and adapted to receive inputs from a human operator to virtually execute the mission; a blueprint generator coupled to the simulator and adapted to generate a mission blueprint of the instructions based on the virtual execution of the mission; and at least one robot adapted to receive the mission blueprint and autonomously execute the mission in the environment based on the mission blueprint.

### BRIEF DESCRIPTION OF THE DRAWINGS

The present invention will hereinafter be described in conjunction with the following drawing figures, wherein like numerals denote like elements.

FIG. 1 is a schematic diagram of a system in accordance with an exemplary embodiment of the present invention; and

FIG. 2 is a flow diagram of a method in accordance with an exemplary embodiment of the present invention.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

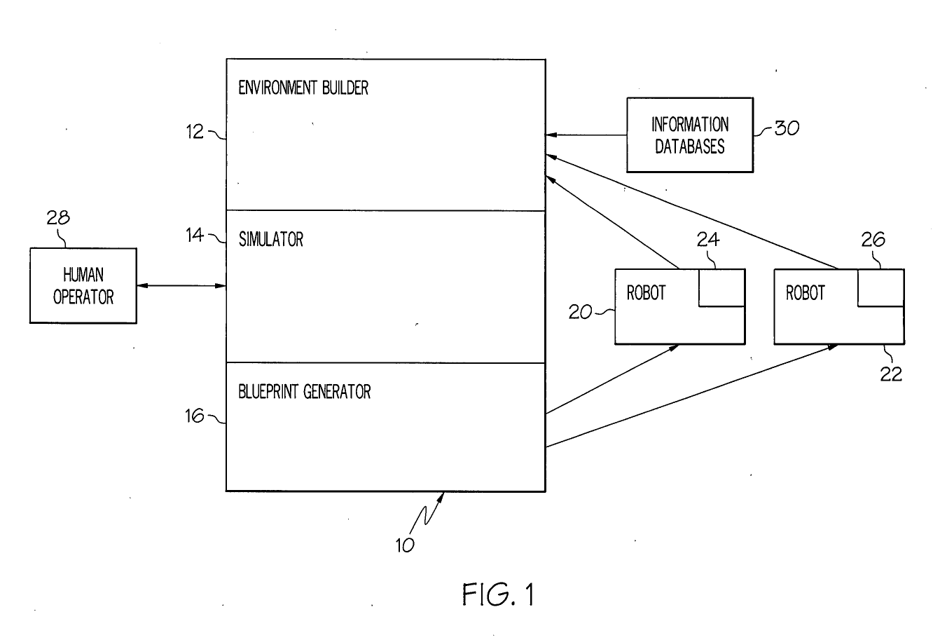

Referring now to the drawings, FIG. 1 is a schematic diagram of a system 10 in accordance with an exemplary embodiment of the present invention. The system 10 provides instructions that enable autonomous execution of one or more tasks in an environment. Typically, the tasks are executed autonomously by one or more robots 20, 22. In the exemplary embodiment, the control system 10 comprises an environment builder 12, a simulator 14, and a blueprint generator 16.

As shown in FIG. 1, the system 10 of the exemplary embodiment utilizes the robots 20, 22 to gather information with sensors 24, 26 about the environment. The sensors 24, 26 can be visual, infrared, radar, sonar, or any other type of sensor that is operable to collect information about the environment. The sensors 24, 26 may or may not be considered part of the system 10. The information collected by the sensors 24, 26 may vary, but is preferably related to the topology of the environment and the objects in the environment. The sensors 24, 26 may sense identification markings and/or signals from specific objects in the environment to more precisely identify the objects and their locations. As necessary, the robots 20, 22 can move, either autonomously or under human operator control, to collect additional information about the environment. Although the illustrated embodiment includes the sensors 24, 26 on the robots 20, 22, the sensors 24, 26 are not necessarily part of the robots 20, 22. The sensors 24, 26, including the mechanism for providing information back to the system 10, can be completely separate from the robots 20, 22. Furthermore, two robots 20, 22 and two sensors 24, 26 are shown for simplicity, although a greater or lesser number of robots and sensors can be provided.

The robots 20, 22 can provide information about the environment to the system 10 either directly or through intervening components or systems. Alternatively, sensors separate from the robots 20, 22 can provide information about the environment to the system 10 either directly or through intervening components or systems. As another alternative, existing information from information databases 30 can provide information about the environment to the system 10 either directly or through intervening components or systems. The system 10 provides the information from the sensors 24, 26 and/or databases 30 to the environment builder 12. The environment builder 12 builds an environment model of the environment for use by the simulator 14. The model can include 2D, 2.5D, or 3D maps or simulations of the environment, including the objects and obstacles in the environment and the locations of the robots 20, 22, based on the aggregation of information from the sensors 24, 26 and/or databases 30. The information provided to the model can include the relative or absolute locations of the objects or landmarks in the environment, and of the robots 20, 22. The model can include a map with a 360° view of information or a lesser field of view. Multiple databases 30, robots 20, 22, and/or additional sensors 24, 26 in different locations and/or multiple visualization points can provide a stereoscopic or higher order view of the environment. Moreover, the system 10 can instruct the robots 20, 22 to move and/or collect additional information to supplement the environment model.

The environment builder 12 provides the environment model to the simulator 14 for displaying the simulation to a human operator 28. The term “human operator” generally refers to one or more humans or other sources that can provide input to the system 10. The simulation can be displayed on, for example, a CRT, an LCD, or a holograph. The simulator 14 additionally enables the human operator 28 to designate items in the simulation as necessary. For example, the human operator 28 may be necessary to distinguish between two boxes stacked on top of each other, or tag items with designations for later reference. The input of the human operator 28 can include inputs via any combination of mouse, joystick, trackball, keyboard, touch-screen, or any other device suitable for generating input from the human operator and providing the input to the simulator 14.

Using the same or different controls, the human operator 28 can execute a virtual mission within the simulator 14 that can represent an intended mission for the robots 20, 22 within the environment. The mission can include any task or series of tasks to be performed by the robots 20, 22. The simulator 14 will include models based on the capabilities of the robots 20, 22, the information from the databases 30 and gathered by the sensors 24, 26, the designations provided to the simulator 14 by the human operator 28, and any other information provided to the system 10.

The human operator 28 can also input parameters into the simulation that model boundary conditions at which the robots 20, 22 should halt activity and wait for human intervention or take an alternative action. For example, the boundary condition can include “robot tilt should not exceed 7°” or “do not stay out of sunlight for more than 30 minutes in any 60 minute period.” Areas of occlusion or a prohibited movement for the robots 20, 22 may also be delineated so that they can be avoided, or possibly identified for further observation and consideration. The human operator 28 can move the robots 20, 22 around the environment to additionally define and/or refine the simulation of the environment. Alternatively, the robots 20, 22 can autonomously move to additionally define and/or refine the simulation of the environment.

The simulator 14 can also simulate or generate absolute or relative headings, velocities and positions for the robots within the simulation to execute a forward, backward, or turning motion, or in general for any motion of the robots 20, 22 and objects within the environment. These mimic the conditions and activities within the environment. When executing the mission, one robot or another point or device within the environment can be an “absolute position of reference,” and all robots can use that position for assisting in maintaining the relative positions of all robots and objects.

The simulator 14 provides the dynamic and interactive simulation to the human operator 28 to control the virtual robots and objects in the virtual environment that correspond to the robots 20, 22, obstacles, and objects in the actual environment. In particular, the simulator 14 enables the human operator 28 to support articulation and movement of the robots and the objects while avoiding obstacles in the virtual environment that corresponds to the actual environment.

The human operator 28 coordinates the robots in the simulation to do one or more tasks. For example, two robots in the simulation can be coordinated to pick up a beam and move it to point A, pick up a second beam and move to point A, and then fasten the beams together. The human operator 28 can trace a path through the environment for the robots and coordinate the movements of the robots. The simulator 14 supports the human operator 28 in generating this sequence of events via interactive control of the robots by the human operator 28 in the simulation.

The human operator 28 should provide a more efficient coordination of activities for the robots within the simulation. The control of the robots by the human operator 28 does not need to be in the “real time” speed of the robots 20, 22. The speed can be accelerated to a speed that the human operator 28 can comfortably control the simulated robots. This speed is typically orders of magnitude faster than the real time speed of the actual robots 20, 22.

The human operator 28 can perform tasks for multiple robots within the simulation, and rearrange or otherwise coordinate various modes of operation to accomplish these tasks. For example, a “parallel” mode indicates that both robots can execute this movement in parallel. A “sync” mode requires that both robots complete tasks to a certain point before continuing. A “simultaneous” mode indicates that the robots must perform a task together. A “serial” mode indicates that one robot must complete a task to a given point before the other robot can begin or continue its next task.

Macros can be generated or built into the simulation to support well known or tedious activities to relieve the human operator 28 from generating finely detailed motion. For instance, the operator may not have to generate the steps for a robot to grasp a beam or to fasten two beams together. This could be a predetermined activity that the robot knows how to do, or a predetermined sequence of commands that the simulator 14 can automatically generate. The human operator 28 may simply position the virtual robot in the approximate location and generate a “grasp” or “fasten beams together” command via, for instance, a mouse click or button push.

After or as the human operator 28 completes the virtual mission in the simulation, the blueprint generator 16 generates a mission blueprint for execution of the mission. The mission blueprint can be, for example, a large sequence of instructions and supporting data for the robots 20, 22 based on the inputs of the human operator 28 within the simulator 14.

The mission blueprint is provided to the robots 20, 22 for essentially autonomous execution. The robots 20, 22 have the necessary software and hardware to receive the mission blueprint, and execute the mission blueprint. For example, the robots 20, 22 have the necessary software and hardware to navigate and manipulate the objects in the environment, execute individual instructions and macros, synchronize with other robots, and any other necessary function for execution of the mission. The autonomous execution of the mission by the robots 20, 22 can be accomplished without human assistance. The mission blueprint anticipates all of the actual parameters of the robots 20, 22 and the environment, including, for example, the position, velocity, and headings of the robots 20, 22, the location of objects and obstacles, and the movement of robot-manipulated objects. If necessary, the mission blueprint can adjust the parameters of the mission relative to the virtual mission. For example, the blueprint can adjust the anticipated speed of the robots 20, 22 to those expected during the mission as compared to the typically much faster virtual speed at which the human operator 28 performed the virtual mission. General criteria can also be provided for determining when a given step of the mission blueprint failed within the environment. In this scenario, the system can be signaled to provide a necessary adaptation or additional human operator 28 action.

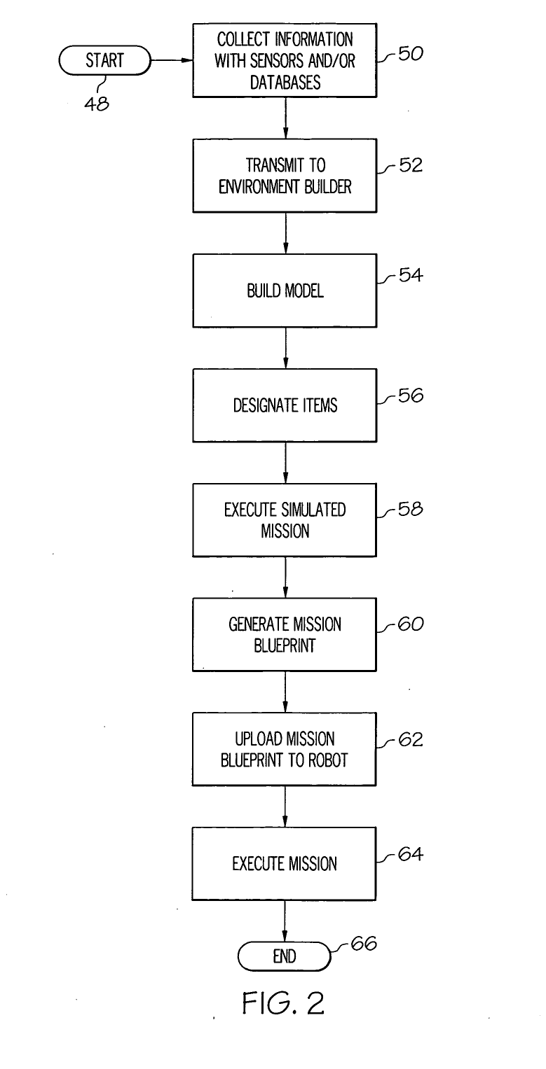

FIG. 2 is a flow diagram of a method in accordance with an exemplary embodiment of the present invention that starts at point 48. In step 50, information is collected from the sensors and/or databases about an environment. In step 52, the information is transmitted to an environment builder. In step 54, the simulator builds an environment model. In step 56, a human operator designates items in the environment model. In step 58, the human operator executes a virtual mission in the simulator. In step 60, a mission blueprint of instructions for the robot is generated. In step 62, the mission blueprint is provided to the robots. In step 64, the robots execute the mission in accordance with the mission blueprint, and the method ends at point 66.

The present invention enables a more efficient and accurate generation of instructions for execution by an autonomous system. The present invention can reduce or eliminate the problems associated with human-assisted or human-in-the-loop robotics.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. A system for generating instructions for at least one robot to execute a mission in an environment, comprising:
an environment builder adapted to receive information related to the environment and to form a model of the environment based on the information;
a simulator coupled to receive the model from the environment builder and adapted to receive inputs from a human operator to virtually execute the mission; and
a blueprint generator coupled to the simulator and adapted to generate a mission blueprint of the instructions based on the virtual execution of the mission.

2. The system of claim 1, wherein the mission blueprint is autonomously executable by the at least one robot to execute the mission.

3. The system of claim 1, wherein the simulator includes a visual display and at least one of a mouse, joystick, keyboard, touch screen, and a human/computer interface device for receiving the inputs from the human operator.

4. The system of claim 1, wherein the information includes topographical information.

5. The system of claim 1, wherein the model includes a map of the environment.

6. The system of claim 1, wherein the simulator is adapted to receive additional information about the model.

7. The system of claim 1, further comprising at least one of
at least one sensor, and
at least one database, said at least one sensor and at least one database configured to gather and supply the information related to the environment builder.

8. The system of claim 1, wherein the simulation includes boundary conditions for the at least one robot.

9. The system of claim 1, wherein the simulator is adapted to direct the at least one robot to gather additional information related to the environment.

10. The system of claim 1, wherein the environment builder is adapted to additionally receive the information from a database.

11. A method for generating instructions for at least one robot to execute a mission in an environment, comprising:
receiving information related to the environment;
forming a model of the environment based on the information;
receiving inputs from a human operator to virtually execute the mission; and
generating a mission blueprint of the instructions based on the virtual execution of the mission.

12. The method of claim 11, further comprising
providing the mission blueprint to the at least one robot for autonomous execution thereof.

13. The method of claim 11, further comprising
visually displaying the simulation to the human operator,
wherein the receiving inputs step includes receiving inputs via at least one of a mouse, joystick, keyboard, touch screen, and a human/computer interface device.

14. The method of claim 11, wherein the receiving information step includes receiving topographical information.

15. The method of claim 11, wherein the forming step includes forming a map of the environment.

16. The method of claim 11, further comprising
providing additional information about the simulation by the human operator.

17. The method of claim 11, further comprising
gathering the information related to the environment with at least one of at least one sensor and at least one database.

18. The method of claim 11, further comprising
providing the simulation with boundary conditions for the at least one robot.

19. The method of claim 11, further comprising
directing the at least one robot to gather additional information related to the environment.

20. A system for autonomous execution of a mission in an environment, comprising:
an environment builder adapted to receive information related to the environment and to form a model of the environment based on the information;
a simulator coupled to receive the model from the environment builder and adapted to receive inputs from a human operator to virtually execute the mission;
a blueprint generator coupled to the simulator and adapted to generate a mission blueprint of the instructions based on the virtual execution of the mission; and
at least one robot adapted to receive the mission blueprint and autonomously execute the mission in the environment based on the mission blueprint.
